(19) United States
(12) Patent Application Publication
(10) Pub. No.: US 2004/0025292 A1
(43) Pub. Date: Feb. 12, 2004

(54) Six-wheel trolley for use in movable wall panel systems

(76) Inventor: N. Douglas Owens, Lynn, IN (US)

Correspondence Address: BAKER & DANIELS, 300 NORTH MERIDIAN STREET, SUITE 2700, INDIANAPOLIS, IN, 46204-1782, US

(21) Appl. No.: 10/601,969

(22) Filed: Jun. 23, 2003

Related U.S. Application Data
(60) Provisional application No. 60/391,672, filed on Jun. 26, 2002.

(51) Int. Cl. E05D 15/16

(52) U.S. Cl. 16/102

(57) ABSTRACT

The present invention involves a trolley for use in movable wall panel system having auxiliary wheels positioned on opposite sides and opposite ends of the trolley. The movable wall panel system includes multiple wall panels supported by a pair of trolleys that are movable along an overhead track having X-intersections. Each trolley is engageable to the movable wall panel by a hanging device. Each trolley includes four main rotatable trolley wheel assemblies that engage and move within the overhead track. The trolley further includes two rotatable auxiliary wheels each having a diameter that is substantially smaller than the diameter of the main wheel assemblies. The auxiliary wheels are also substantially smaller in width than the main wheel assemblies. The trolley has a plate and the auxiliary wheels attach to the plate by a spacer plate.

This application claims priority to U.S. Provisional Application No. 60/391,672 filed Jun. 26, 2002, entitled “SIX-WHEEL TROLLEY FOR USE IN MOVABLE WALL PANEL SYSTEM”.

### BACKGROUND OF THE INVENTION

1. Field of the Invention

The present invention pertains to a movable wall panel system in which wall panels are movable to partition large rooms into smaller rooms. More particularly, the present invention relates to trolleys that are connected to the wall panels and operate to move wall panels along a track.

2. Description of the Related Art

Operable walls or partitions, also known as movable wall panel systems, find useful application in a variety of venues, such as classrooms, offices, convention centers, hospitals, etc. In these venues, the operable walls can be utilized to efficiently divide or compartmentalize interior space into a multitude of separate, smaller rooms. In particular, the operable wall panels are typically connected by a hanging device to trolleys having wheels that roll within an overhead track. Travel of the trolleys within the track allows the panels to be moved between a stacked arrangement in a storage location, and a wall-forming, extended arrangement in alignment with the overhead track.

The overhead tracks often include corners and intersections to permit the compartmentalization of the interior space into a variety of different arrangements and to permit the efficient stacking of wall panels. However, prior trolleys riding within these overhead tracks often experience difficulty negotiating the intersections. For instance, when the trolley reaches the intersection, the weight of the wall panel causes the wheels of the trolley to drop into and rest in the intersection of the track. The wall panel then becomes stuck at the intersection until considerable upward and translational force is exerted on the trolley to move the trolley wheels up and over the gap in the intersection. In many cases, the wall panels are very heavy making it extremely difficult for a user to effectively move the wall panel across the intersection. Consequently, in order to provide an effective and efficient movable wall panel system, it is important that the trolleys be able to navigate through the intersections and corners smoothly and effectively.

Several wall systems have been developed to address the problem of navigating through intersections. Such systems include: U.S. Pat. No. 4,837,891 to Toma, U.S. Pat. No. 4,159,556 to Dickson, and U.S. Pat. No. 3,708,916 to Karp Jr. Toma attaches slide pads, represented as reference numbers 64 and 67 in FIGS. 12-16, to the track to reduce the vertical elevation drop in intersections. Dickson installs bearings 46, shown in FIG. 2, within the tracks adjacent the intersection to support the trolley as it moves through the intersection. As shown in FIGS. 4 and 8 of Karp, Karp includes platforms 28 between adjacent wheels. The platforms support the trolley as it crosses the intersection. Despite these attempts, these systems have not proven to be completely successful in enabling the smooth and effective movement of trolleys through intersections.

In addition to these prior art references, an 8-wheel system has been developed for use with tracks having X-intersections. In the 8-wheel system, each panel incorporates two 8-wheel trolleys. Finally, a 6-wheel system has also been developed in which two additional wheels, the same size as the main wheels of the trolley, were added to a 4-wheel trolley, as illustrated in FIG. 1B. The two additional wheels are located on opposite sides and opposite ends of the trolley. This system has created a new set of problems, namely an increase in manufacturing costs and a significant increase in trolley width. The increase in trolley width further results in an increase in the stacking depth and the amount of storage space required. Furthermore, some panel systems include switching assemblies such as that described in U.S. patent application Ser. No. 09/706,041. In these systems the addition of full-sized wheels can interfere with the switching assemblies.

### SUMMARY OF THE INVENTION

The present invention involves a trolley for use in movable wall panel system with auxiliary wheels for traversing intersections. The movable wall panel system includes multiple wall panels supported by a pair of trolleys that movable along an overhead track having X-intersections. Each trolley is engageable to the movable wall panel by a hanging device. Each trolley includes four main rotatable trolley wheel assemblies that engage and move within the overhead track and at least two auxiliary wheels positioned on opposite sides and opposite ends of the trolley.

In one aspect of the invention, the trolley further includes two auxiliary wheels each having a diameter that is substantially smaller than the diameter of the main wheels. In another aspect, the auxiliary wheels are also substantially smaller in width than the wheel assemblies.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a top schematic view of a movable wall panel system, including an overhead track having intersections.

FIG. 1A is a perspective view of the movable wall panel system of FIG. 1.

FIG. 1B is a top view of a prior art 6-wheel trolley.

FIG. 2 is a top view of storage area of a movable wall panel system.

FIG. 3 is an exploded view of an X-intersection of FIG. 1A.

FIG. 4 is a side view of a prior art 4-wheel trolley.

FIG. 4A is a top view of the prior art 4-wheel trolley of FIG. 4.

FIG. 5 is a side view of a trolley according to one embodiment of the present invention.

FIG. 5A is a front view of the trolley of FIG. 5.

FIG. 5B is a top view of the trolley of FIG. 5.

FIG. 6 is a cross section of an intersection of an overhead track and the trolley of FIG. 5 traveling within the overhead track.

FIG. 7 is top view of two of the trolleys of FIG. 5 in a stacked arrangement.

Corresponding reference characters indicate corresponding parts throughout the several views. Although the drawings represent embodiments of the present invention, the drawings are not necessarily to scale and certain features may be exaggerated in order to better illustrate and explain the present invention. The exemplifications set out herein illustrate embodiments of the invention, in several forms, and such exemplifications are not to be construed as limiting the scope of the invention in any manner.

### DESCRIPTION OF THE PRESENT INVENTION

The embodiments disclosed below are not intended to be exhaustive or limit the invention to the precise forms disclosed in the following detailed description. Rather, the embodiments are chosen and described so that others skilled in the art may utilize their teachings.

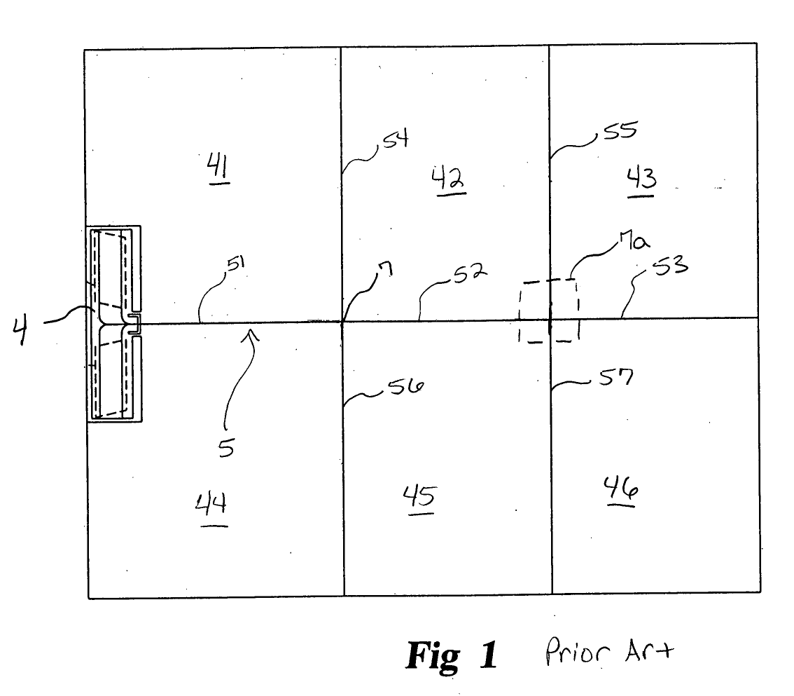

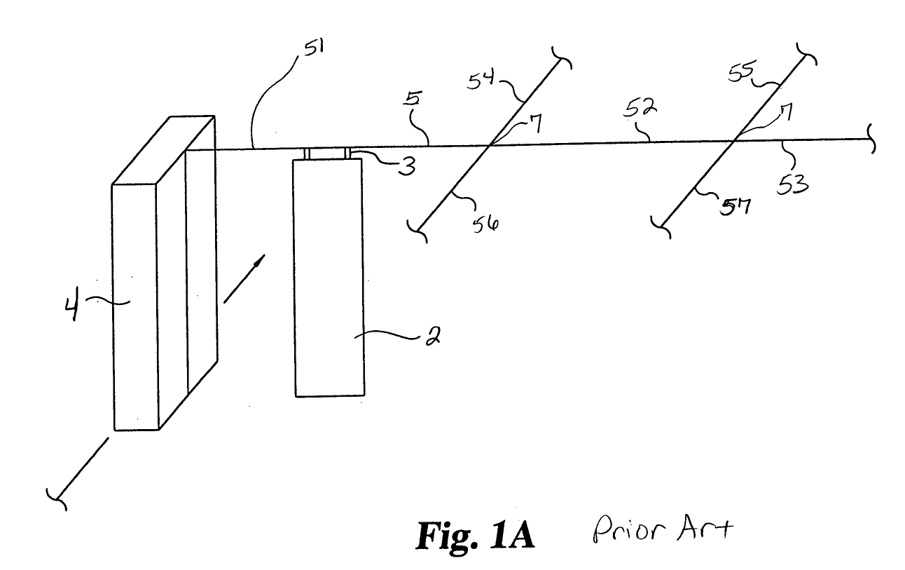

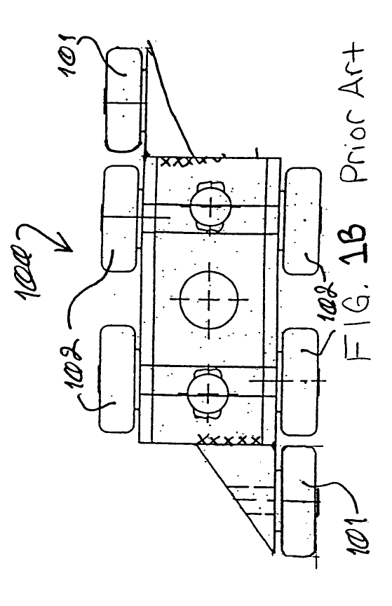

Movable wall systems, such as those shown in FIGS. 1 and 1A, and described in U.S. patent application Ser. No. 09/706,041, assigned to the assignee of the present application, and the disclosure of which is incorporated by reference, may be used to efficiently divide or compartmentalize a large room into a multitude of separate, smaller rooms. The movable wall panel system includes a multitude of panels 2 that extend from the floor to the ceiling of a room. Each wall panel 2 is connected, by hanging device 3, to two trolleys 6 that roll within overhead track 5. Travel of trolleys 6 within track 5 allow panels 2 to be moved between a stacked arrangement in storage location 4, and a wall-forming, extended arrangement in alignment with overhead track 5. FIG. 1A shows one of panels 2 being moved from stacking storage location 4 to a wall-forming arrangement.

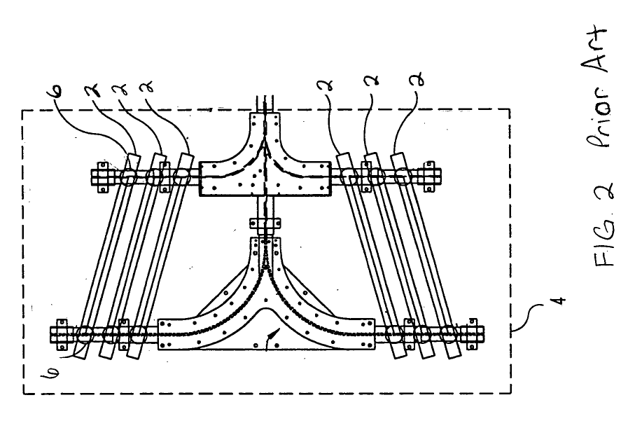

As shown in FIG. 2, when stored within storage location 4 then panels 2 are stacked along track sections. When panels 2 are in the stacked position, corresponding trolleys 6 of each panel are stacked adjacent one another. Therefore, the size of storage location 4 needed to store panels 2 is directly related to the size of trolleys 6 and the ability of trolleys 6 to efficiently line up.

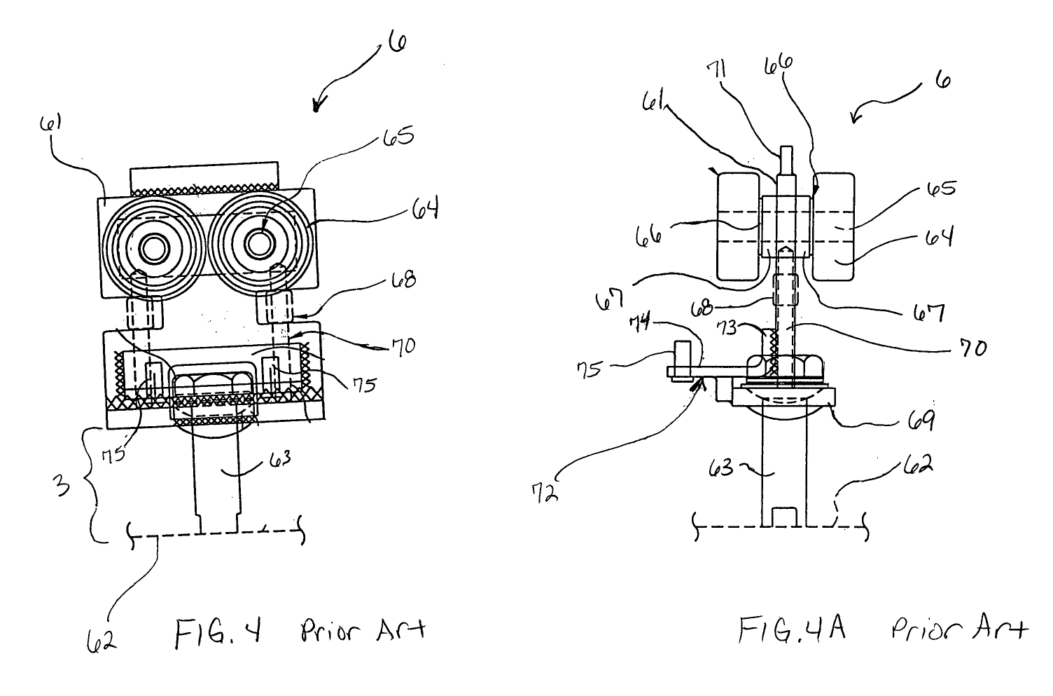

Prior art 4-wheel trolley 6 is illustrated in FIGS. 4 and 4A. Trolley 6 includes vertically oriented trolley plate 61 to which is welded bottom plate 69. Trolley bolt 63 extends through bottom plate 69 and is secured to the top section of movable wall panel 62, abstractly shown in dashed lines. Four rotatable wheel assemblies 64 that roll along track 5 are mounted on trolley axles 65, which extend through wheel spacers 66, spacer plates 67 and vertical trolley plate 61. Guide bushings 68 are rotatably mounted on pins 70 and serve to reduce friction between trolley 6 and track 5.

Referring back to FIG. 1, in order to provide a variety of compartmental arrangements, overhead track 5 is composed of track segments or sections 51-57 mounted to the ceiling (not shown). For example, FIG. 1 illustrates track 5 designed to compartmentalize a room into as many as six smaller rooms 41-46. Track 5 is merely illustrative, as the track configuration may have a variety of configurations. Overhead track 5 may also include switch assemblies (a description of which can be found in U.S. patent application Ser. No. 09/706,041) for directing the movement of panels 2. In this case, trolley 6 will also include one or more diverter elements designed to cooperate with the switch assemblies of track 5. For instance, trolley 6 of FIGS. 4 and 4A includes center diverter 71 that extends upwardly beyond wheel assemblies 64 and engages complementary diverters provided in switch assemblies of track 5. Trolley 6 also includes a side diverter element having an L-shaped steel plate formed by short leg flange 73 disposed at a right angle to long leg flange 74 and a pair of diverter pins 75 extending upward from long leg flange 74. These diverter pins function to engage complementary guide plates provided on track 5.

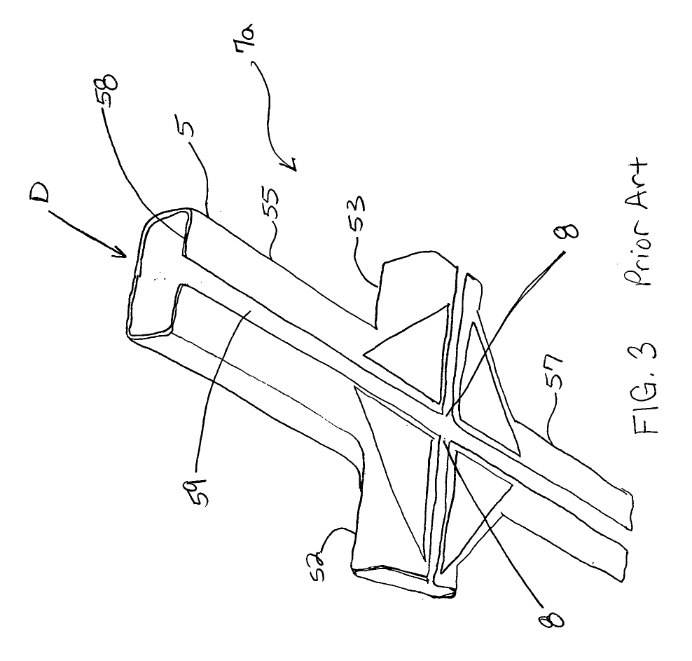

As shown in FIG. 3, the track sections are typically made of steel, or other durable metal such as aluminum, and are generally square in vertical cross section. However, trolley 6 may be modified to accommodate shapes and sizes other than the exemplary embodiment. Wheel assemblies 64 of trolley 6 ride along bottom wall 58 of track 5. Bottom wall 58 of track 5 includes slot 59 extending longitudinally along the track and through which hanging device 3 passes to connect trolley 6 to panel 2.

As shown in FIGS. 1 and 1A, track 5 may also include several intersecting track sections 7, also referred to as X-intersections 7. FIG. 3 shows an exploded view of X-intersection 7a of FIG. 1. Although the design of X-intersection 7 facilitates the division of a room into a variety of different arrangements, X-intersection 7 poses a significant challenge to the movement of panels 2. Referring to FIG. 3, as a trolley (not shown) moves along track 5 in direction D (indicated by arrow D), it travels along bottom wall 58 of track segment 55. When trolley 6 reaches X-intersection 7, longitudinal slot 59 of track sections 55 and 57 meets longitudinal slot 59 of track sections 52 and 53, thereby forming gap 8 in bottom wall 58 where track segments 55 and 57 meet. Consequently, when trolley 5 reaches gap 8, wheel 64 of trolley 5 can fall into gap 8, causing trolley 5 to get stuck at X-intersection 7.

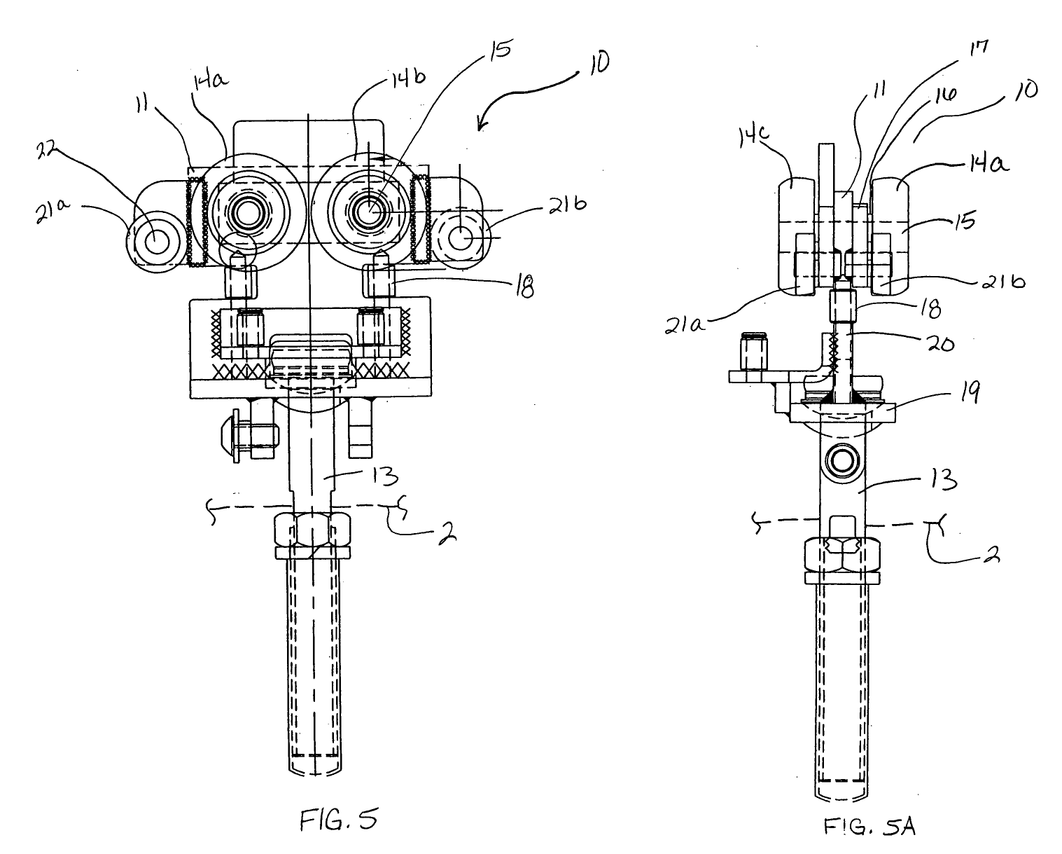

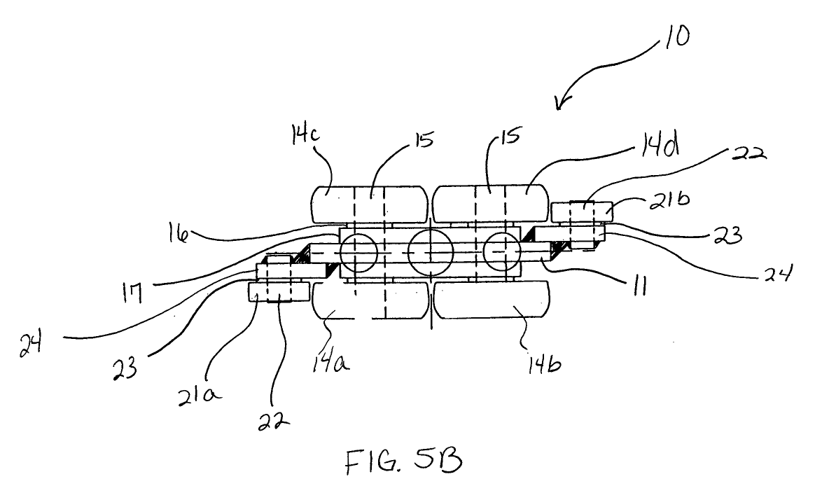

FIGS. 5-5B illustrate trolley 10 according to one embodiment of the present invention. Trolley 10 includes a vertically oriented trolley plate 11 to which is attached to bottom plate 19. Trolley 10 is secured to movable wall panel 2 (abstractly represented by dashed lines) by trolley bolt 13. Four main rotatable trolley wheel assemblies 14a-14d that roll along overhead track 5 are mounted on trolley axles 15, which extend through wheel spacers 16, spacer plates 17 and vertically oriented trolley plate 11. Guide bushings 18 located in notches 19a formed in vertical trolley plate 11 are rotatably mounted on pins 20 and serve to reduce friction between trolley 10 and the track 5 along which it rides.

In addition to main rotatable trolley wheel assemblies 14, trolley 5 includes two rotatable auxiliary wheels 21, leading auxiliary guide wheel 21a and trailing auxiliary wheel 21b, located on opposite sides and opposite ends of vertical trolley plate 11 (See FIG. 5B). The terms leading and trailing, as used with respect to auxiliary wheels, refers to the position of the auxiliary wheel during wall movement. The auxiliary wheel that it is in the front position of the moving trolley is the leading auxiliary wheel, while the auxiliary wheel in the back position of the moving trolley is the trailing auxiliary wheel. Each auxiliary wheel 21 is rotatably mounted on auxiliary wheel axle 22, which extends through auxiliary wheel spacer 23 and auxiliary wheel spacer plate 24. Auxiliary wheel spacer plate 24 is attached to vertical trolley plate 11.

In the exemplary embodiment of FIGS. 5, 5A, and 5B, auxiliary wheels 21 are smaller both in diameter and in width than main wheel assemblies 14. Auxiliary wheels 21 may be smaller and lighter than main wheel assemblies 14 because auxiliary wheels 21 support a lesser amount of load for a shorter period of time. That is, main wheel assemblies support the entire weight of panel 2 when outside X-intersection 7. In this embodiment, auxiliary wheels 21 do not need to support the entire weight borne by trolley 5 when crossing X-intersection 7 because when crossing X-intersection 7 trolley 5 is also supported by at least two main wheel assemblies 14. In addition, auxiliary wheels 21 support the weight borne by trolley 5 for only a short period of time, the time required to traverse X-intersection 7, and therefore the auxiliary wheels do not have to endure the same load as main wheels 14. Consequently, auxiliary wheels 21 may be constructed to accommodate a lesser load amount that larger main wheels 14 need to accommodate.

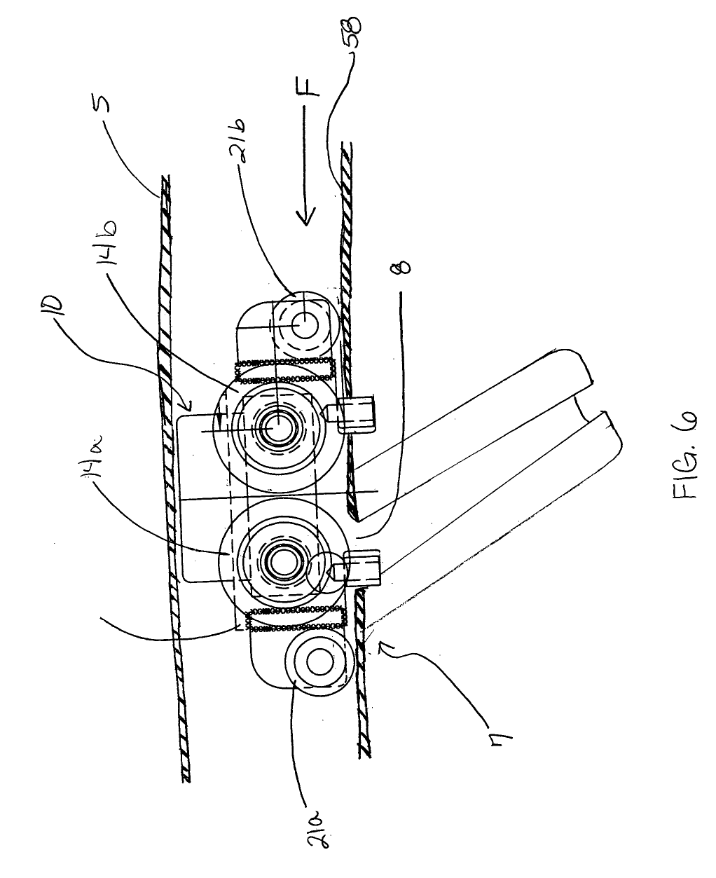

FIG. 6 shows a cross section of X-intersection 7 of overhead track 5. FIG. 6 further shows trolley 10 of the present invention traveling in direction F along bottom wall 58 of track 5. When trolley 10 reaches gap 8 of X-intersection 7, leading auxiliary 21a wheel crosses gap 8 first. Leading auxiliary wheel 21a does not collapse into gap 8 because, while it crosses gap 8, leading auxiliary wheel 21a is supported by wheel assemblies 14a-d. Once leading auxiliary wheel 21a crosses gap 8, it supports main wheel assemblies 14a and 14c preventing them from collapsing into gap 8. As wheel assemblies 14b and 14d cross gap 8, trailing auxiliary wheel 21b remains on bottom wall 58 just before gap 8. Trailing auxiliary wheel 21b supports main wheel assemblies 14b and 14d as they cross gap 8, thereby preventing main wheel assemblies 14b and 14d from dropping into gap 8. Trailing auxiliary wheel 21b crosses gap 8 without dropping into gap 8 because it is supported by main wheel assemblies 14, which are now resting or riding on bottom wall 58 at the other side of gap 8.

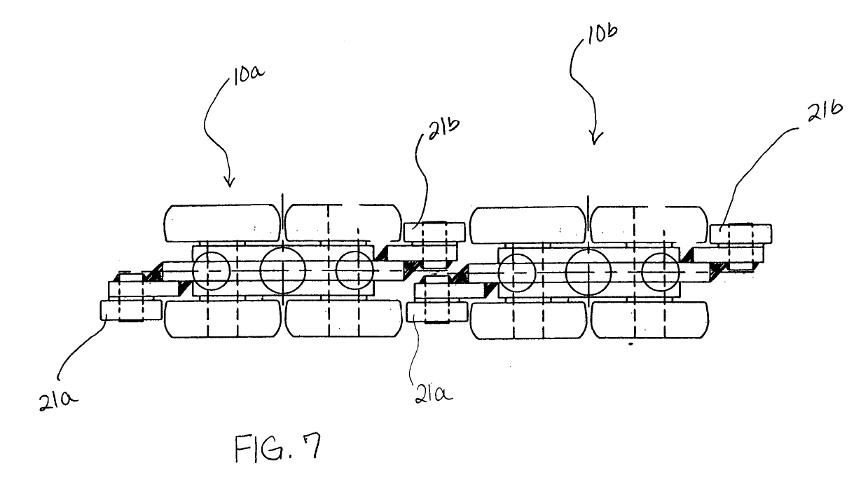

In addition to facilitating the smooth and efficient negotiation of intersections, trolley 5 of the present invention facilitates efficient stacking of panels 2 when in storage location 11. FIG. 7 shows a top view of two trolleys 10a, 10b of the present invention in a stacked arrangement. In the stacked arrangement, trailing auxiliary wheel 21b of first trolley 10a overlaps with leading auxiliary wheel 21a of second trolley 10b. This overlap minimizes the amount of space between each panel, thereby allowing the panels to be stacked close together and minimizing the amount of storage space required.

Unlike prior art trolley 100 of FIG. 1B, which uses auxiliary wheels 101 that are the same size as main wheels 102, the trolley of the present invention uses smaller auxiliary wheels which ultimately conserves even more stacking space. In addition, the use of smaller, lighter auxiliary wheels reduces material and manufacturing costs. Similarly, compared to the 8-wheel prior art trolley described in the Background, the trolley of the present invention uses only two smaller auxiliary wheels. This allows the trolleys to overlap during stacking and minimizes the stacking space required to stack and store the panels. In fact, compared to the prior art trolley system, the trolley of the present invention reduces stacking depth by up to 1.5″ per panel or 22%. Manufacturing cost savings may be as high at 60% compared to prior designs.

In addition, unlike the prior 6-wheel and 8-wheel trolley systems, the smaller size of the guide wheels relative to the wheel assemblies are beneficial because the guide wheels do not interfere with the switch assemblies.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A trolley for use in movable wall panel system having multiple wall panels supported by and movable along an overhead track having X-intersections, the trolley comprising:
a trolley body;
a hanging device attached to said trolley body engageable to the movable wall panel;
four trolley wheel assemblies rotatably supported by said trolley body and engageable and movable within the overhead track; and
at least two auxiliary wheels, at least one of said auxiliary wheels being dimensioned smaller than any of said four trolley wheel assemblies, said at least two auxiliary wheels being constructed to said trolley body and positioned on opposite sides and opposite ends of said trolley body.

2. The trolley of claim 1 wherein said auxiliary wheels are smaller in diameter than the diameter of said trolley wheel assemblies.

3. The trolley of claim 1 wherein said auxiliary wheels are smaller in width than the width of said trolley wheel assemblies.

4. The trolley of claim 1 wherein said trolley body comprises a trolley plate.

5. The trolley of claim 4 wherein at least one of said auxiliary wheels include a spacer plate attached to said trolley plate.
